(19) United States
(12) Patent Application Publication
(10) Pub. No.: US 2022/0231460 A1
(43) Pub. Date: Jul. 21, 2022

(54) UNIVERSAL SERIAL BUS PLUG AND RECEPTACLE

(71) Applicant: Hewlett-Packard Development Company, L.P., Spring, TX (US)

(72) Inventors: Douglas Keith Markwardt, Spring, TX (US); Jose Ticy Lo, Spring, TX (US)

(73) Assignee: Hewlett-Packard Development Company, L.P., Spring, TX (US)

(21) Appl. No.: 17/615,203

(22) PCT Filed: Sep. 12, 2019
(86) PCT No.: PCT/US2019/050743

§ 371 Date: Nov. 30, 2021

(51) Int. Cl. H01R 13/645

(52) U.S. Cl. CPC H01R 13/6456

(57) ABSTRACT

An example system can include a universal serial bus (USB) type C (USB-C) receptacle comprising a flexible locator tab that displaces responsive to insertion of a USB-C plug and the USB-C plug comprising a locator slot to mate with the flexible locator tab. The system can include surface-to-surface contacts between the USB-C receptacle and the USB-C plug when the USB-C plug and the USB-C receptacle are mated.

### BACKGROUND

Universal Serial Bus (USB) is a standard that establishes specifications for cables and connectors and protocols for connection, communication, and power supply between computing devices and/or peripheral devices. USB cables, which include a plug to insert into a USB receptacle, can be a plurality of different types having different uses and capabilities including, for instance USB-A, USB-B, USB-C, mini-USB, micro-USB, and USB-3 types.

### BRIEF DESCRIPTION OF THE DRAWINGS

FIG. 1 is a diagram of a system including a USB receptacle having a flexible locator tab and a USB plug having a locator slot according to an example;

FIG. 2 is a diagram of an assembly including a USB receptacle having a flexible locator tab and a USB plug having a locator slot according to an example;

FIG. 3 is another diagram of a system including a USB receptacle having a flexible locator tab and a USB plug having a locator slot according to an example; and

FIG. 4 is a diagram of a system including a USB receptacle having a flexible locator tab and a USB plug according to an example.

### DETAILED DESCRIPTION

USB cables are used to transfer data and charge devices, among other uses. Different USB connector types provide different functions and speeds and may not be compatible with one another. USB connectors can be used to transfer data across interfaces that make up shared boundaries between components of a computing device or system. These interfaces can include hardware and/or software, and in some examples can allow for high-speed transfer of data via the USB connector and a corresponding USB receptacle. As used herein, a computing device can be a mechanical or electrical device that transmits or modifies energy to perform or assist in the performance of human tasks. Examples include personal computers, laptops, tablets, smartphones, mobile devices, digital notebooks, printing devices, and gaming consoles, among others.

A USB type C (USB-C) connector system includes a plug having a rotationally symmetrical connector and a receptacle to receive the connector. For example, a connection can be made in a right-side-up or right-side-down orientation. USB-C connections systems can be used to connect both hosts and devices. USB-C connector systems utilize a point-contact connection (e.g., 24-pin connector) for transfer of data and/or energy transfer.

Examples of the present disclosure allow for a more secure and reliable connection as compared to other USB-C connection systems. For instance, some examples include a 2-part connection, including a plug portion having a rectangular shape with a locator slot and a receptacle portion to receive the plug and having a locator tab to fit in the location slot while retaining the same interior features of current USB-C connections. In some examples, the rectangular shape of both the plug and the receptacle allows for surface-to-surface contacts, which together with point contacts, resulting in a more snug and secure connection, improved alignment, and improved retention force. The rectangular shape may allow for more accurate manufacturing (e.g., stamping) of the USB plug and receptacle. Such examples of the present disclosure reduce shifting and other movements (e.g., lateral movement of the USB plug) resulting in reduced errors in the associated data stream. In some examples of the present disclosure the receptacle may be backwards compatible such that the receptacle can receive an older or different version of the plug (e.g., non-rectangular-shaped, no locator slot, etc.).

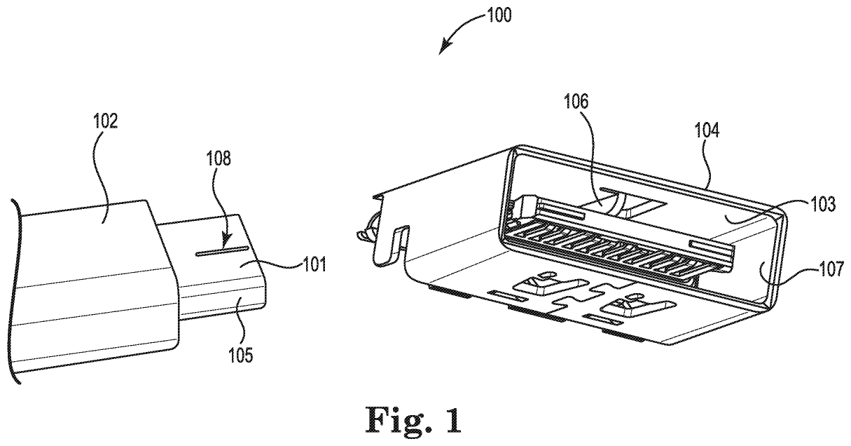

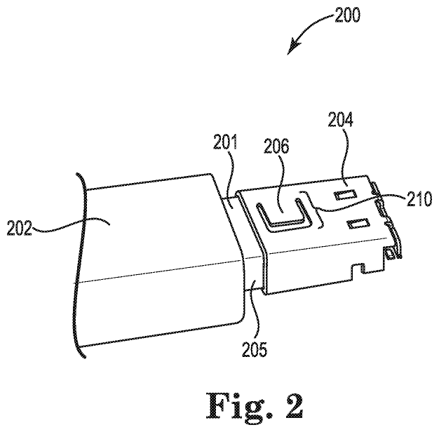

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. Multiple analogous elements within one figure may be referenced with a reference numeral followed by a hyphen and another numeral or a letter. For example, 308-1 may reference element 08-1 in FIGS. 3 and 308-2 may reference element 08-2, which can be analogous to element 08-1. Such analogous elements may be generally referenced without the hyphen and extra numeral or letter. For example, elements 308-1 and 308-2 may be generally referenced as 308.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

FIG. 1 is a diagram of a system 100 including a USB receptacle 104 having a flexible locator tab 106 and a USB plug 102 having a locator slot 108 according to an example. In some examples, the USB receptacle 104 can be a USB-C receptacle. When the USB plug 102 (e.g., USB-C plug) is inserted into the USB receptacle 104, the flexible locator tab 106 on the USB receptacle 104 displaces until the locator slot 108 of the USB plug 102 mates with the flexible locator tab 106. For instance, as the USB plug 102 is inserted into the USB receptacle 104, the flexible locator tab 106 is pushed up until it can mate (e.g., fall into place) with the locator slot 108. In some examples, the USB plug 102 is flexible such that portions of the USB plug 102 are displaced responsive to insertion of the USB plug 102 into the USB receptacle 104 until the flexible locator tab 106 reaches the locator slot 108 for mating. The mating of the flexible locator tab 106 with the locator slot 108 can reduce shifting of the connection and can reduce or prevent transfer and communication issues.

In some examples, the USB plug 102 includes an additional locater slot (not illustrated in FIG. 1) opposite the locator slot 108. The additional locater slot may allow for insertion of the USB plug 102 in different orientations while maintaining a snug connection. For instance, the flexible locator tab 106 mates with the locator slot 108 when the USB plug 102 is in a first position. When the USB plug 102 is in a second position, for instance a 180-degree turned position (e.g., upside down), the flexible locator tab 106 mates with the additional locator slot.

When the system 100 is assembled such that the USB plug 102 is fully inserted into the USB receptacle 104 and the flexible locator tab 106 is mated with the locator slot 108, surface-to-surface contacts are present between the USB receptacle 104 and the USB plug 102. For instance, an inner side surface 107 of the USB receptacle 104 can have a surface-to-surface contact with outer side surface 105 of the USB plug 102 when the system 100 is assembled. In some examples, top surface 101 of the USB plug 102 can have a surface-to-surface contact with an inner top surface 103 of the USB receptacle 104. Similar, an inner side surface opposite the surface 107 and a lower inner surface opposite the surface 103 of the USB receptacle 104 can have surface-to-surface contacts with an outer side surface opposite the surface 105 and an outer bottom surface opposite the surface 101 of the USB plug 102, respectively. The surface-to-surface contacts can reduce shifting of the connection and can reduce or prevent transfer and communication issues as compared to connectors having point contact connections, but no surface-to-surface contacts.

In some examples, the USB receptacle 104 is rectangular shaped and the USB plug 102 is rectangular shaped. For instance, the portion of the USB plug 102 inserted in the USB receptacle 104 and the USB receptacle 104 may have a smaller radius and more squared-off shape as compared to other USB systems. For instance, a different USB-C connector may have rounded edges that do not allow for surface-to-surface contacts like the rectangular shapes of the USB receptacle 104 and the USB plug of the present disclosure.

In some instances, the USB receptacle 104 may be backwards compatible with a different USB plug. For instance, in an example in which the USB receptacle 104 is a USB-C receptacle, it may receive a different USB-C plug. Put another way, the USB-C receptacle 104 can be rectangular-shaped while the different USB-C plug has rounded edges. In such an example, the flexible locator tab 106 on the USB receptacle 104 can create a snugger fit between the USB receptacle 104 and a different USB plug as compared to a fit between a different USB receptacle and a different USB plug.

To make the USB receptacle 104 backwards compatible with a different USB plug, the inner contacts of the USB receptacle 104 and the USB plug 102 may be the same as different USB receptacles and plugs. For instance, in an example in which the USB receptacle 104 is a USB-C receptacle, the inner contacts may be the same as those in a different USB-C receptacle. Similar, in an example in which the USB plug 102 is a USB-C plug, the inner contacts may be the same as those in a different USB-C plug.

FIG. 2 is a diagram of an assembly 200 including a USB receptacle 204 having a flexible locator tab 206 and a USB plug 202 having a locator slot according to an example. Assembly 200 includes the flexible locator tab 206 mated with the locator slot of the USB plug 202. In some examples, the flexible locator tab 206 is U-shaped, as shown at 210, allowing for displacement of the flexible locator tab 206 while the USB plug 202 is inserted into the USB receptacle 204. The flexible locator tab 206 is displaced until it is able to mate (e.g., fall into, slide into, etc.) the locator slot of the USB plug 202. The assembly 200 facilitates high-speed transfer of data because of the consistent snug fit between the USB plug 202 and the USB receptacle 204. For instance, surface-to-surface contacts between the inner surfaces of the USB receptacle 204 and the outer surfaces (e.g., surfaces 201, 205) of the USB plug 202 can reduce movement between the USB plug 202 and the USB receptacle 204, which in turn reduces and/or prevents connection, data transfer, and/or electrical energy transfer issues. Put another way, responsive to insertion of the USB plug 202 into the USB receptacle 204 (e.g., forming the assembly 200), surface-to-surface contacts are formed between the USB plug 202 into the USB receptacle 204, and data can be shared across a high-speed interface using the assembly 200.

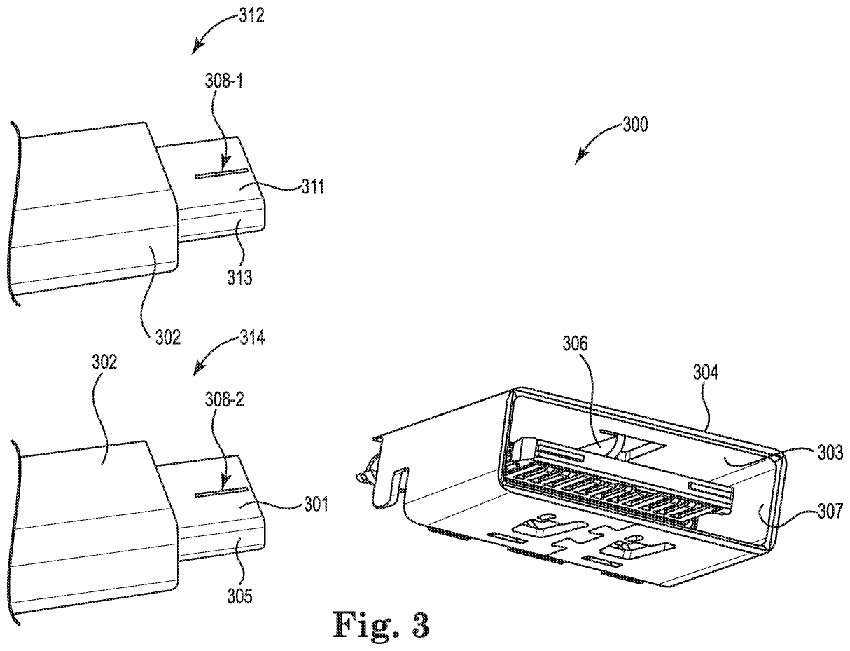

FIG. 3 is another diagram of a system 300 including a USB receptacle 304 having a flexible locator tab 306 and a USB plug 302 having a locator slot 308 according to an example. In some examples, the USB receptacle 304 is a USB-C receptacle, and the USB plug 302 is a USB-C plug. System 300 includes a rectangular-shaped USB receptacle 304 having a locator tab 306 and a rectangular-shaped USB plug 302 having a first locator slot 308-1 on a first side 312 of the USB plug 302, and a second locator slot 308-2 on a second, opposite side 314 of the USB plug 302. A portion of the flexible locator tab 306 can be located on a centerline of the USB receptacle 304. The first and the second locator slots 308 can be located opposite each other, and both can be located on a respective centerline of the USB plug 302. The centerline locations can, for example, allow for more accurate alignment of the flexible locator tab 308 and the locator slot 308. The first and the second locator slots 308, in some examples, can be located approximately perpendicular to an opening of the USB receptacle 304 (e.g., approximately parallel to the side surfaces 313, 305). As used herein, “approximately” includes being within a particular margin, range, and/or threshold). The locator tab 306 can be flexible such that it is displaced until the flexible locator tab 306 reaches the first locator slot 308-1 or the second locator slot 308-2 (e.g., based on the insertion orientation) of the USB plug 302 for mating.

The first locator slot 308-1 can mate with the locator tab 306 responsive to insertion of the USB plug 302 into the USB receptacle 304 in a first orientation (e.g., first side 312 up, also referred to as “right-side up”). The second locator slot 308-2 can mate with the locator tab 306 responsive to insertion of the USB plug 302 into the USB receptacle 304 in a second orientation (e.g., second side 312 up, also referred to as “upside down”). This can allow for insertion of the USB plug 302 into the USB receptacle in different orientations while retaining the surface-to-surface contacts and the secure fit of the locator slot 308 mated with the locator tab 306.

For instance, the surface-to-surface contacts remain whether the first side 312 of the USB plug is up or the second side 314 of the USB plug 302 is up. For instance, in the first example (e.g., first side 312 up), top outer surface 311 of the USB plug 302 has surface-to-surface contact with top inner surface 303 of the USB receptacle 304, and outer side surface 313 of the USB plug 302 has surface-to-surface contact with inner side surface 307 of the USB receptacle. In the same example, surface 301 of the USB plug 302 (which in this example would be an outer bottom surface opposite surface 311) has surface-to-surface contact with a bottom inner surface of the USB receptacle 304, while surface 305 of the USB plug 302 (which in this example would be an outer side surface opposite surface 313) has surface-to-surface contact with an inner side surface opposite the inner side surface 307 of the USB receptacle 304.

In the second example (e.g., second side 314 up), top outer surface 301 of the USB plug 302 has surface-to-surface contact with top inner surface 303 of the USB receptacle 304, and outer side surface 305 of the USB plug 302 has surface-to-surface contact with inner side surface 307 of the USB receptacle. In the same example, surface 311 of the USB plug 302 (which in this example would be an outer bottom surface opposite surface 301) has surface-to-surface contact with a bottom inner surface of the USB receptacle 304, while surface 313 of the USB plug 302 (which in this example would be an outer side surface opposite surface 305) has surface-to-surface contact with an inner side surface opposite the inner side surface 307 of the USB receptacle 304.

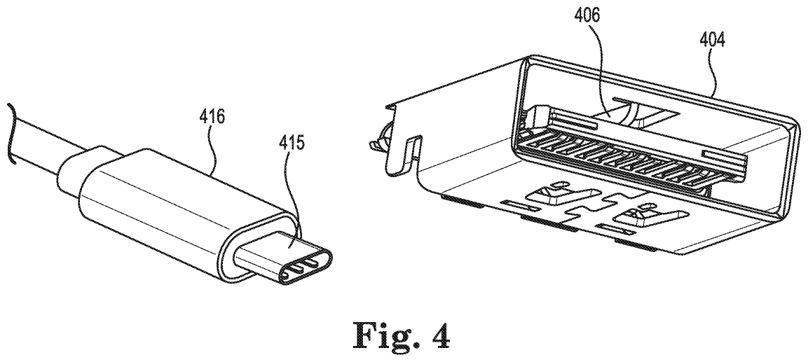

FIG. 4 is a diagram of a system including a USB receptacle 404 having a flexible locator tab 406 and a USB plug 416 according to an example. In the example illustrated in FIG. 4, the USB receptacle 404 is a USB-C receptacle, and the USB plug 416 is a different USB-C plug type. USB receptacle 404 can be backwards compatible with the USB plug 416 such that the USB plug 416 and it's rounded-edge connector 415 can be inserted into USB receptacle 404 and function as desired. For instance, data and/or electrical energy can be transferred and communication can proceed with the USB receptacle 404 and the USB plug 416 are connected. The flexible locator tab 406 can displace when the USB plug 416 is inserted into the USB receptacle 404 and remain displaced. In such an example, the flexible locator tab 406 on the USB receptacle 404 can create a snugger fit (e.g., increased resistance to movement) between the USB receptacle 404 and the USB plug 416 as compared to a fit between a different USB receptacle and the USB plug 416.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

What is claimed is:

1. A system, comprising:
a universal serial bus (USB) type C (USB-C) receptacle comprising a flexible locator tab that displaces responsive to insertion of a USB-C plug; and
the USB-C plug comprising a locator slot to mate with the flexible locator tab,
wherein the system comprises surface-to-surface contacts between the USB-C receptacle and the USB-C plug when the USB-C plug and the USB-C receptacle are mated.

2. The device of claim 1, further comprising the USB-C receptacle to receive the USB-C plug such that the flexible locator tab is displaced until the flexible locator tab reaches the locator slot of the USB-C plug for mating with the flexible locator tab.

3. The device of claim 1, wherein the flexible locator tab is U-shaped.

4. The device of claim 1, wherein:
the USB-C receptacle is rectangular shaped; and
the USB-C plug is rectangular shaped.

5. The device of claim 1, wherein the USB-C plug comprises an additional locator slot opposite the locator slot.

6. The device of claim 5, wherein:
the flexible locator tab mates with the locator slot when the USB-C plug is inserted in a first orientation; and
the flexible locator tab mates with the additional locator slot when the USB-C plug is inserted in a second orientation.

7. A system comprising:
a rectangular-shaped universal serial bus (USB) receptacle comprising a locator tab; and
a USB plug having a first locator slot on a first side of the USB plug and a second locator slot on a second, opposite side of the USB plug,
wherein the first locator slot mates with the locator tab responsive to insertion of the USB plug into the USB receptacle in a first orientation; and
wherein the second locator slot mates with the locator tab responsive to insertion of the USB plug into the USB receptacle in a second orientation.

8. The system of claim 7, wherein:
a portion of the locator tab is located on a centerline of the USB receptacle;
the first locator slot is located on a first centerline of the USB plug; and
the second locator slot is located on a second centerline of the USB plug opposite the first centerline.

9. The system of claim 7, wherein the locator tab is flexible such that the flexible locator tab is displaced until the flexible locator tab reaches the first locator slot or the second locator slot of the USB plug for mating with the flexible locator tab.

10. The system of claim 7, further comprising the USB receptacle and the USB plug sharing data across a high-speed interface responsive to insertion of the USB plug into the USB receptacle.

11. The system of claim 7, wherein the system comprises surface-to-surface contacts between the USB receptacle and the USB plug responsive to insertion of the USB plug into the USB receptacle.

12. A system comprising:
a rectangular-shaped universal serial bus type C (USB-C) receptacle comprising a flexible locator tab; and
a USB-C plug having a locator slot to mate with the locator tab when the USB-C plug is inserted into the USB receptable.

13. The system of claim 12, wherein the flexible locator tab is displaced responsive to insertion of the USB-C plug until the flexible locator tab reaches the locator slot for mating.

14. The system of claim 12, wherein the USB-C plug is flexible such that portions of the USB-C plug are displaced responsive to insertion of the USB-C plug until the flexible locator tab reaches the locator slot for mating.

15. The system of claim 12, wherein the locator slot is approximately parallel to outer edges of the USB-C plug and approximately perpendicular to an opening of the USB-C receptable.
